(19) United States
(12) Patent Application Publication
(10) Pub. No.: US 2003/0187715 A1
(43) Pub. Date: Oct. 2, 2003

(54) Method and system for assisting management of client contact

(76) Inventor: Laurence D. Foss JR., Exeter, NH (US)

Correspondence Address: Laurence D. Foss, Jr., 11 Sanborn Street, Exeter, NH, 03833, US

(21) Appl. No.: 10/108,104

(22) Filed: Mar. 27, 2002

(51) Int. Cl. G06F 17/60

(52) U.S. Cl. 705/10

(57) ABSTRACT

A computer implemented method for assisting a business person in maintaining contact with at least one client, by recording information specific to a client into a database through a computer program, establishing predetermined future contact dates, and recording them on the computer database, whereby the business person has an intent to consider initiating contact with the client on those dates and receiving notification from the computer, through the computer program, when the predetermined contact dates arrive to contact the client.

### FIELD OF THE INVENTION

This invention relates to client management. In particular, the invention provides an interactive database for recording client information to assist and promote future contact with clients and prospective clients. More specifically, the invention prompts the salesperson/computer user to contact clients and creates the means for initiating the repeated contact, through cards and electronic correspondence.

### BACKGROUND OF THE INVENTION

There is a wide range of sales industry occupations presently, ranging from automotive or real estate sales to product vendors or retail businesses. Effective sales and service businesses attract clients in a number of ways. Ways to attract clients range from advertising across any of an assortment of mediums to generating positive word of mouth advertising through positive customer contact. Most business for individual salespeople or companies is generated through repeat customer business and word of mouth advertising, although ironically more money is spent on blind, broad advertising targeted at creating new business customers.

Part of the reason for this spending conflict is it is more convenient and cost efficient to advertise generically. Once a buyer or potential buyer leaves the selling environment there are few cost effective tool in place to target that customer for repeat business. Some businesses send general mailings to their past clients, referring to them as preferred customers, but those mailings lack any personal feel. Some businesses will send personalized greeting cards to customers, but the work involved in locating the information to be included in the greeting cards and generating those cards makes it cost prohibitive to mail to all, but the most lucrative of clients.

Currently, a number of software packages exist for salesperson to store client information. The software allows the computer user to record personal information about the clients and prospective clients. The user/salesperson can then open their database file at a later date to retrieve that personal information. As a result, the computer becomes nothing more-than an electronic notebook for the salesperson.

Another problem with present software for salespeople is the lack of incentive to record client information in the database. Most full-time salespeople make their living on commissions or, at the least, earn their salaries off their sales figures. Unless recording the client information into an electronic database will result in a foreseeable increase in their sales, salespeople will be reluctant to do the work. Because most salesperson software only provides a means of recording client information and, perhaps, analyzing the information, the software is helpful to the sales business, but not necessarily the salesperson. Salespeople become aware of this lack of incentive and shy away from doing the clerical work.

The software presently available for salespersons and business people can also get quite expensive. The companies producing the software create updates as often as once a year and the changes in computer technology make it important to keep up with the updates. The price for each update multiplied by the number of workstations at each business can make it undesirable to use the electronic databases.

One method for salespersons to target buyers, or potential buyers that have spoken to the salesperson and given the salesperson their address, is by mailing cards. Thank you cards or other mailings remind the customer of their visit and can leave a positive thought about the salesperson in the mind of the consumer. However, to mail correspondence presently, salespeople must thumb through their databases or paper fees of clients to see who is worth corresponding with or who the salesperson has a reason to correspond with. The time consuming nature of this task makes pursuing it undesirable.

Another problem with mailings is they become expensive. A business can have hundreds or thousands of clients or potential clients it comes into contact with in the span of a few years. To send cards, newsletters, or other mailings to some or all of them can be quite expensive between postage and printing costs. As a result, the mailings become cost prohibitive.

### SUMMARY OF THE INVENTION

This invention results from the realization that software for salespeople can provide client management methods with sufficient benefits and incentives the salespeople, thereby getting efficient use for its purpose, and enhancing cost effectiveness of its use by alerting salespeople of useful occasions for contacting clients and creating cost effective means for contacting them.

It is therefore an object of this invention to create a cost effective tool to target customers for repeat business.

It is a further object of this invention to provide software that actively assists salespeople.

It is a further object of this invention to provide incentive for salespeople to enter their buyer or potential buyer's personal information into the database.

It is a further object of this invention to provide a cost effective product for purchase and updating for an entire sales staff.

It is a further object of this invention to provide a time efficient means of reinitiating contact with buyers or potential buyers.

It is a further object of this invention to provide a cost efficient means of reinitiating contact with buyers or potential buyers.

### BRIEF DESCRIPTION OF THE DRAWINGS

FIG. 1 is a flow chart showing the steps taken by the computer program user performing the method of the invention.

FIG. 2 is a block diagram showing the interconnecting elements of the invention.

FIG. 3 is a diagram of the processor usable medium.

### DETAILED DESCRIPTION OF THE INVENTION

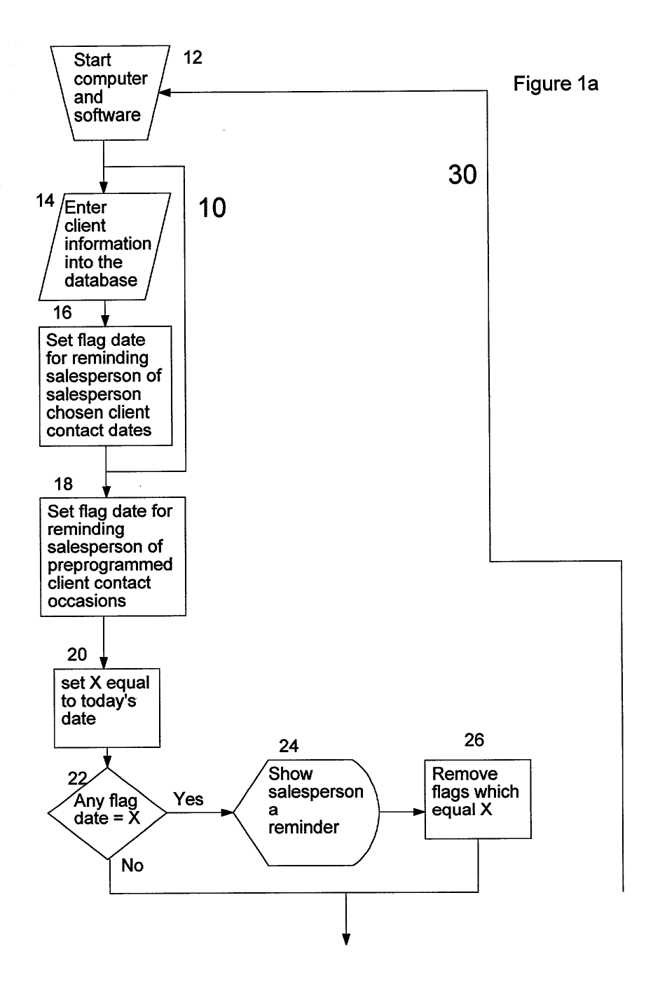

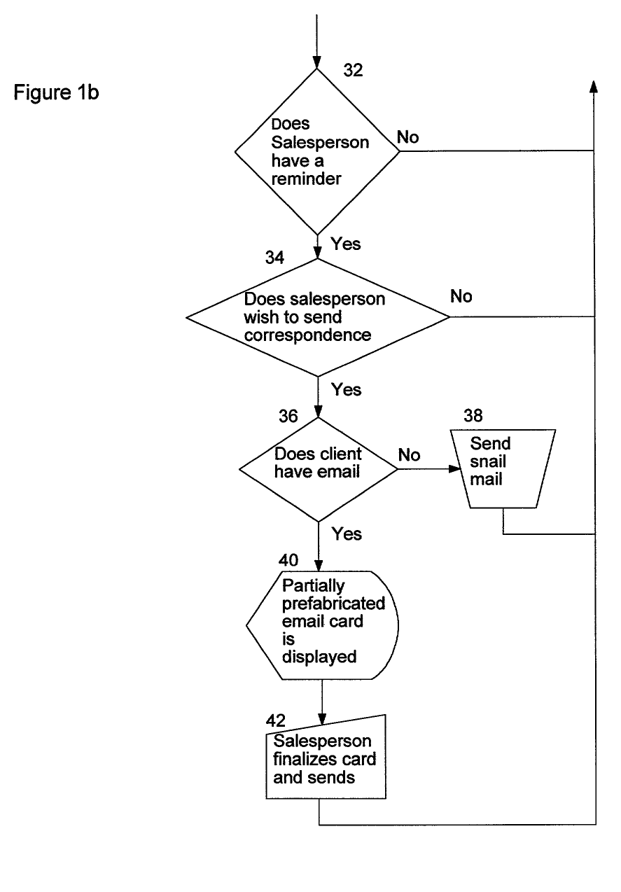

One embodiment of the invention is a computer-implemented method 10 in FIG. 1. The method assists a businessperson in maintaining contact with at least one client. The client or clients in this invention include customers, prospective customers, or other business contacts. The businessperson can be a sales person or anyone whose employment requires customers or clients. The method requires access to a computer loaded with the type of software covered by this patent or access to a computer with access to the program covered by this patent.

To initiate this method, the computer must be turned on and the program accessed 12 in FIG. 1. The method is several steps, including recording information specific to a client into a database 14 through the computer. The next step is establishing at least one predetermined future contact date for the businessperson to contact the client 16 and 18. The predetermined future contact date can be set specifically by the businessperson 16 or through preprogrammed contact occasions 18, possibly calculated from the recorded information specific to the client. The program must keep track, in some form, of the time and/or date; one form would be to track only the date 20. The next step is performed by the computer, which is determining if the future contact date has either arrived or is near enough to remind the businessperson of the approaching date to contact the client 22. The final step is receiving notification from the computer 24, when the computer determines the contact date arrived or is near enough, to contact the client and deleting the reminder from the system 26. The businessperson is then able to remember/receives a push to contact clients.

One preferred embodiment has the client accessing the computer program through an Internet site. Another preferred embodiment for the computer implemented method involves having at least one predetermined contact date for special occasions, such as birthdays, anniversaries, holidays, or other occasions, is established by the computer program.

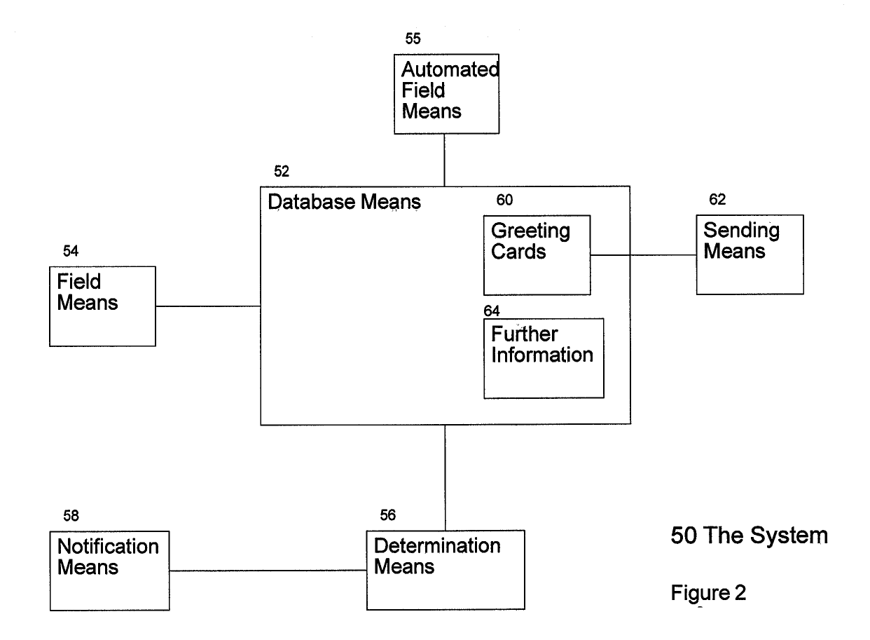

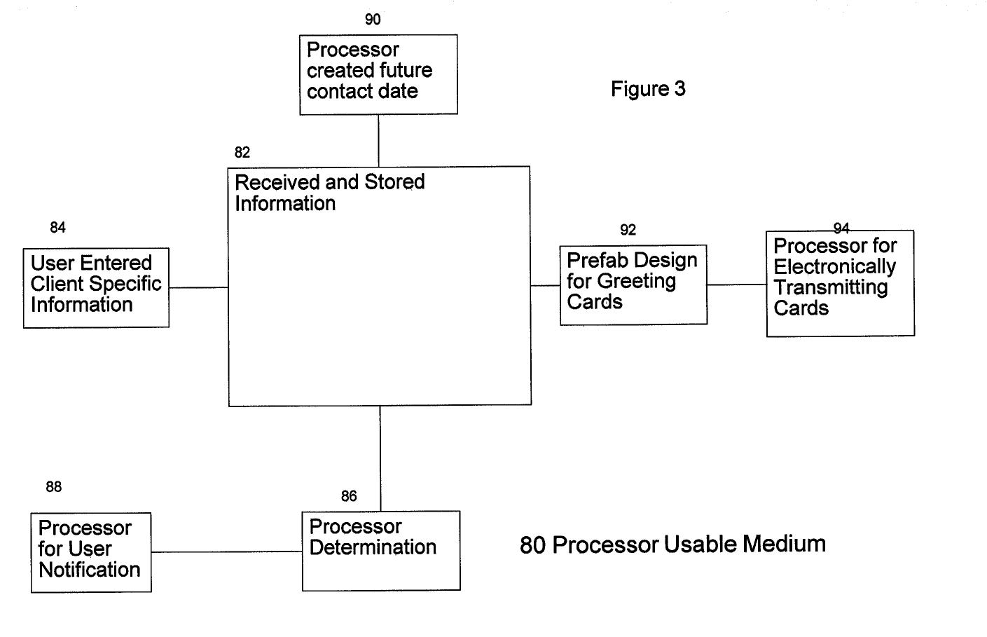

One embodiment of this invention makes contacting clients electronically more convenient 30 in FIG. 2. If the businessperson receives a reminder to contact a client 32 and chooses to contact the client specified in the reminder 34, the program can check to determine if, within the database, the client specific information indicates the client has an email address 36. If the client does not have an email address, the businessperson must send snail mail 38. The snail mail may originate from an at least partially prefabricated design for at least one greeting card stored in the computer database for use in maintaining contact with clients. If the client has an email address, one embodiment of this invention allows the computer to automatically enter client specific information into at least partially prefabricated electronic greeting cards stored in the database 40. Another preferred embodiment involves electronically transmitting the greeting cards through an electronic medium, such as the Internet, to the client 42.

This invention may also be described as a system 50 for assisting a business person in maintaining contact with at least one client. The system has a database means 52 for storing specific information about clients. The database means 52, and/or system 50, may exist on the user's computer, on a network computer, in a location accessible through the Internet, some combination of these three locations, or another location. The system 50 also has a manual field means 54 for entering client information and at least one predetermined future contact date whereby the business person intends to reinitiate contact with the client. The system 50 also has a determination means 56 for determining when a specific contact date, to contact the client, has arrived. When the determination means 56 determines specific contact date arrived, the notification means 58 notifies the businessperson.

The system 50 also has different embodiments. One embodiment is making the system 50 accessible by logging onto an Internet site. Another embodiment involves the system 50 having at least one predetermined future contact date for special occasions, such as birthdays, anniversaries, holidays, or other occasions, created by the system 50 through an automatic field means 55 using the client information stored with the database means 52.

Another embodiment has the database means 52 storing a partially prefabricated design for one or more greeting cards 60 for use in maintaining contact with clients. A further embodiment of this last embodiment allows the system 50 to take client specific information stored with the database means 52 and include some of the information in the prefabricated design for the greeting cards 60 automatically. Another embodiment of this invention includes a sending means 62 within the system 50 for electronically transmitting the greeting cards 60 through an electronic medium, such as the Internet, to the client.

A different embodiment of the invention has the database means 52 storing further information 64, including data on sales completed with a specific client and general sales data for the user. A further embodiment of this embodiment has the further information stored 64 limited to automotive sales data.

Another interpretation of this invention is as a processor usable medium having processor readable code 80 embodied therein for enabling calendaring of client contact times and actively reminding users of those contact times when the times arrive. The processor readable code 80 in said processor usable medium includes processor readable code for causing a processor to receive and store specific information 82 about at least one client. The invention also includes processor readable code 80 for allowing a user to enter client specific information and one or more predetermined future contact dates 84 for contacting clients to become received and stored information 82. The invention also has processor readable code 80 for causing a processor to determine 86 if a predetermined future contact date is imminent, respective to a processor encoded definition of imminent. The invention then has processor readable code 80 for causing a processor to notify 88 the user that the predetermined contact date is imminent.

This invention has additional embodiments, including one where the processor readable code 80 is accessed over the Internet. Another embodiment includes processor readable code for causing a processor to create at least one predetermined future contact date 90 for special occasions, such as birthdays, anniversaries, holidays, or other occasions, through the stored specific client information 82.

Another embodiment requires processor readable code 80 storing a partially prefabricated design for one or more greeting cards 92 for use in maintaining contact with clients. A further embodiment of this embodiment takes some of the processor readable code based stored specific client information 82 and copies it into the prefabricated design for the greeting cards 92 for the specific clients automatically. Another embodiment includes processor readable code for causing a processor to electronically transmit 94 the greeting cards through an electronic medium, such as the internet, to the client.

What is claimed is:

1. A computer implemented method for assisting a business person in maintaining contact with at least one client, the method comprising the steps of:
recording information specific to a client into a database through a computer program and a computer;
establishing at least one predetermined future contact date for the business person to contact the client;
determining the future contact date has arrived to contact the client; and
receiving notification from the computer, through the computer program, when the future contact date arrives to contact the client.

2. The computer implemented method of claim 1 further comprising accessing the computer program through an Internet site.

3. The computer implemented method of claim 1 further comprising establishing predetermined contact date for special occasions, such as birthdays, anniversaries, holidays, or other occasions, by the computer program.

4. The computer implemented method of claim 1 further comprising storing in the database an at least partially prefabricated design for at least one greeting card for use in maintaining contact with clients and the computer program enters client specific information in the greeting cards automatically.

5. The computer implemented method of claim 4 further comprising electronically transmitting the greeting cards through an electronic medium, such as the Internet, to the client.

6. A system for assisting a business person in maintaining contact with at least one client, the system comprising:
a database means for storing specific information about clients;
a field means for entering client information and at least one predetermined future contact date whereby the business person intends to reinitiate contact with the client;
a determination means for determining a specific future contact date, to contact the client, has arrived; and
a notification means for notifying the business person a specific future contact date to contact the client has arrived.

7. The system of claim 6 wherein the system is accessible by logging onto an Internet site.

8. The system of claim 6 wherein at least one predetermined future contact date for special occasions, such as birthdays, anniversaries, holidays, or other occasions, is created by the system through the client information stored on the database.

9. The system of claim 6 wherein the database means has stored in memory an at least partially prefabricated design for at least one greeting card for use in maintaining contact with clients.

10. The system of claim 9 wherein client specific information is included in the prefabricated design for the greeting cards automatically.

11. The system of claim 9 further comprising sending means for electronically transmitting the greeting cards through an electronic medium, such as the Internet, to the client.

12. The system of claim 6 wherein the database means stores further information, including data on sales completed with specific clients and general sales data for the user.

13. The system of claim 12 wherein the further information stored is limited to automotive sales data.

14. A processor usable medium having processor readable code embodied therein for enabling calendaring of client contact times and actively reminding users of those contact times when the times arrive, the processor readable code in said processor usable medium comprising:
processor readable code for causing a processor to receive and store specific information about at least one client;
processor readable code for causing a processor to enter at least one predetermined future contact date for contacting a client;
processor readable code for causing a processor to determine the predetermined future contact date is imminent, respective to a processor encoded definition of imminent; and
processor readable code for causing a processor to notify the user that the predetermined contact date is imminent.

15. The medium according to claim 14, wherein the processor is accessed over the Internet.

16. The medium of claim 14 further comprising processor readable code for causing a processor to create at least one predetermined future contact date for special occasions, such as birthdays, anniversaries, holidays, or other occasions, through the stored client information.

17. The medium of claim 14 wherein the processor has stored in memory an at least partially prefabricated design for at least one greeting card for use in maintaining contact with clients.

18. The medium of claim 17 wherein client specific information is included in the prefabricated design for the greeting cards automatically.

19. The medium of claim 17 further comprising processor readable code for causing a processor to electronically transmit the greeting cards through an electronic medium, such as the Internet, to the client.
